(19) United States
(12) Patent Application Publication
(10) Pub. No.: US 2003/0168387 A1
(43) Pub. Date: Sep. 11, 2003

(54) Screen panel and method of manufacturing same

(75) Inventors: Richard C. Maxson, Maple Grove, MN (US); Steven R. Gilles, Elberfield, IN (US)

Correspondence Address: MOSER, PATTERSON & SHERIDAN, L.L.P., Attn:William Patterson, 0340 Post Oak Blvd., Suite 1500, Houston, TX, 77056, US

(73) Assignee: WEATHERFORD/LAMB, INC., Houston, TX

(21) Appl. No.: 10/094,127

(22) Filed: Mar. 8, 2002

(51) Int. Cl. B07B 1/49

(52) U.S. Cl. 209/399

(57) ABSTRACT

A plastic screen panel is manufactured in two parts. A screen surface is formed to include a plurality of spaced-apart, parallel filter members and a series of top ribs molded over the filter members to maintain the spacing of the filter members. The screen surface is coupled to a support assembly having a series of bottom ribs, which also support and maintain the spacing of the filter members.

### BACKGROUND AND SUMMARY OF THE INVENTION

The present invention relates to screen panels used for filtering products such as coal, and particularly to plastic screen panels. More particularly, the present invention relates to plastic screen panels and a method of manufacturing such panels.

Conventional plastic screen panels typically include a series of spaced-apart, parallel filter members or wires intersected by a series of bottom support members or ribs that run substantially perpendicularly to the filter members and underneath the filter members. A product, such as a coal slurry, is passed over a filter surface formed by the top surfaces of the filter members. The coal and other products too large to fit between the spaced-apart filter members pass over the screen surface, while liquids (e.g. water) and small particles filter between the filter members.

These conventional plastic screen panels are often formed by an injection molding process. As will be readily apparent to those of ordinary skill in the art, the bottom ribs or members typically extend to the top surface of the intersecting filter wires or members to facilitate removal of the formed plastic screen panel from an injection mold. In other words, instead of molding the bottom ribs in a plane below, and supporting, the filter wires (an arrangement which creates difficulties in removal from an injection mold), the bottom ribs are molded largely in the same plane as the filter wires to create a wire/rib lattice (which can be more easily removed from an injection mold). Particularly, when the filter wires have a tapered cross-section, the bottom ribs are molded to extend to the top surface of the filter wires so that the resulting screen panel can be removed from an injection mold.

However, molding the screen panel to include bottom ribs that extend to the top surface of the filter wires interrupts the continuity of the filter gaps between adjacent filter wires and, thereby, decreases the open area of the injection molded screen panel. To keep the filter gaps between adjacent filter wires continuous, and thereby keep the open area of the screen panel as high as possible, other conventional plastic screen panels have been formed wherein the spaced-apart, parallel filter wires are supported on top of the underlying bottom ribs. In this way, in an arrangement with filter wires having tapered cross-sections, the bottom ribs only intersect the filter wires, and obstruct flow, at the bottoms of the filter wires, where, because of their taper, the filter wires are spaced further apart. See, e.g., U.S. Pat. No. 5,687,853 to Askew, the subject matter of which is incorporated by reference herein.

While these panels maintain continuous filter gaps between adjacent filter wires, they often must be formed by processes other than injection molding. Sometimes these other processes (e.g. casting) can be relatively expensive. A plastic screen panel that is formed to include largely uninterrupted filter gaps between adjacent filter wires and which lends itself to injection molding will be welcomed by users and manufacturers of such plastic screen panels.

According to the present invention, a method of manufacturing a screen panel includes forming a plastic screen surface having a plurality of elongated, spaced-apart, substantially parallel surface filter members, at least one end of each filter member being coupled to a surface frame member. A top rib is integrally molded to the filter members on a filter surface defined by the top surfaces of the filter members. A plastic screen support assembly is also formed having a plurality of elongated, spaced-apart, substantially parallel bottom ribs, at least one end of each rib being coupled to a support frame member. The surface frame member is coupled to the support frame member such that the surface filter members are positioned substantially perpendicularly to the bottom ribs and are supported above the bottom ribs.

In preferred embodiments, the screen surface includes numerous, fine, filter members or wires molded with a surrounding frame that holds the numerous filter wires or members together. In preferred embodiments, each filter wire has a generally triangular cross-section. In this way, the top surfaces of the individual filter wires cooperate to form the top filter surface including filter gaps between the adjacent filter wires, which widen from the top surfaces of the filter wires to the bottoms of the filter wires. A series of top ribs are integrally molded to the filter surface, perpendicularly to the filter wires. Because the top ribs are integrally molded to the filter wires, they serve to maintain a consistent filter gap width between the individual filter wires.

The entire screen surface is coupled to a separately formed screen support assembly that includes a plurality of spaced-apart bottom ribs, which, like the surface filter members, are held together by a surrounding support frame member. With the screen surface coupled to the screen support, the individual filter wires run substantially perpendicularly to the underlying bottom ribs and engage notches in the bottom ribs that further serve to hold the filter members or wires in place, again maintaining a consistent filter gap width between the individual filter wires or members.

Additional features and advantages of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a screen panel in accordance with the present invention including a screen surface and a screen support;

FIG. 2 is a magnified view of one end of the screen surface and screen support of FIG. 1;

FIG. 3 is a cross-sectional view of the screen surface and screen support of FIG. 1 taken along line 3-3, showing magnified views of a plurality of filter wires of the screen surface and a plurality of notches of the screen support;

FIGS. 3A, 3B, and 3C illustrate alternate configuration for the filter wires and notches of FIG. 3;

FIG. 4 is a perspective view of another embodiment of a screen panel in accordance with the present invention including a screen surface and a screen support; and

FIG. 5 is a perspective view of yet another embodiment of a screen panel in accordance with the present invention including guides for directing flow over a screen surface.

### DETAILED DESCRIPTION OF THE DRAWINGS

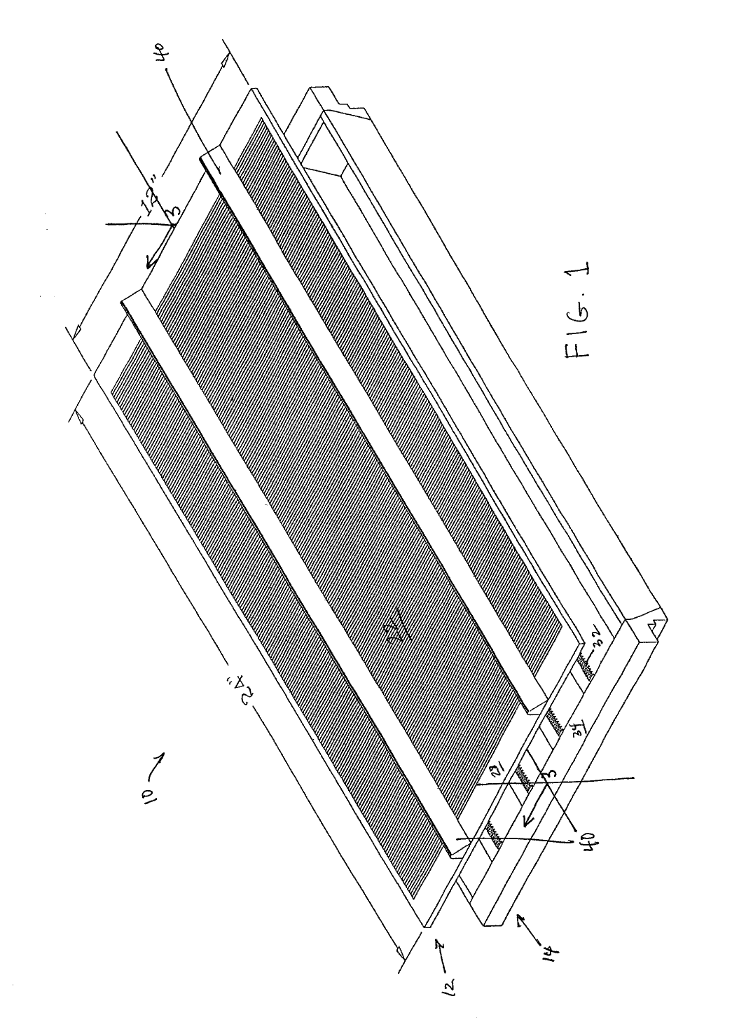

A screen panel 10 in accordance with the present invention is shown in FIG. 1. The screen panel 10 includes a screen surface 12 and a screen support 14. In preferred embodiments, the screen surface 12 and screen support 14 are injection molded out of plastic, preferably polyurethane.

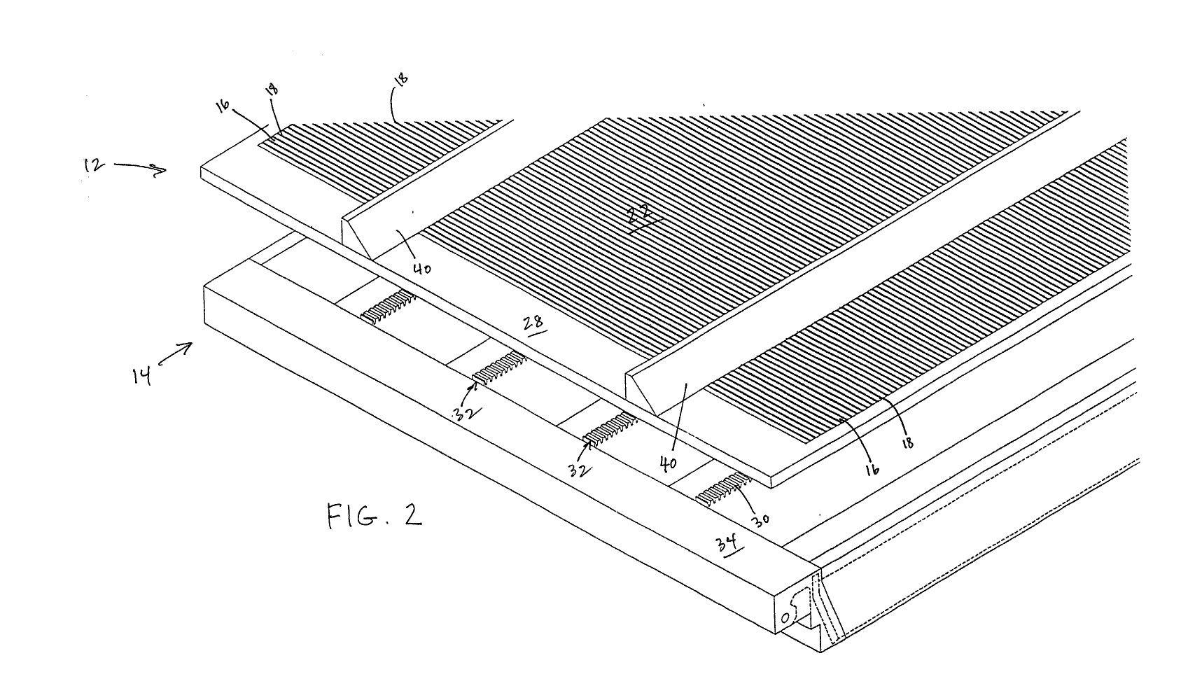

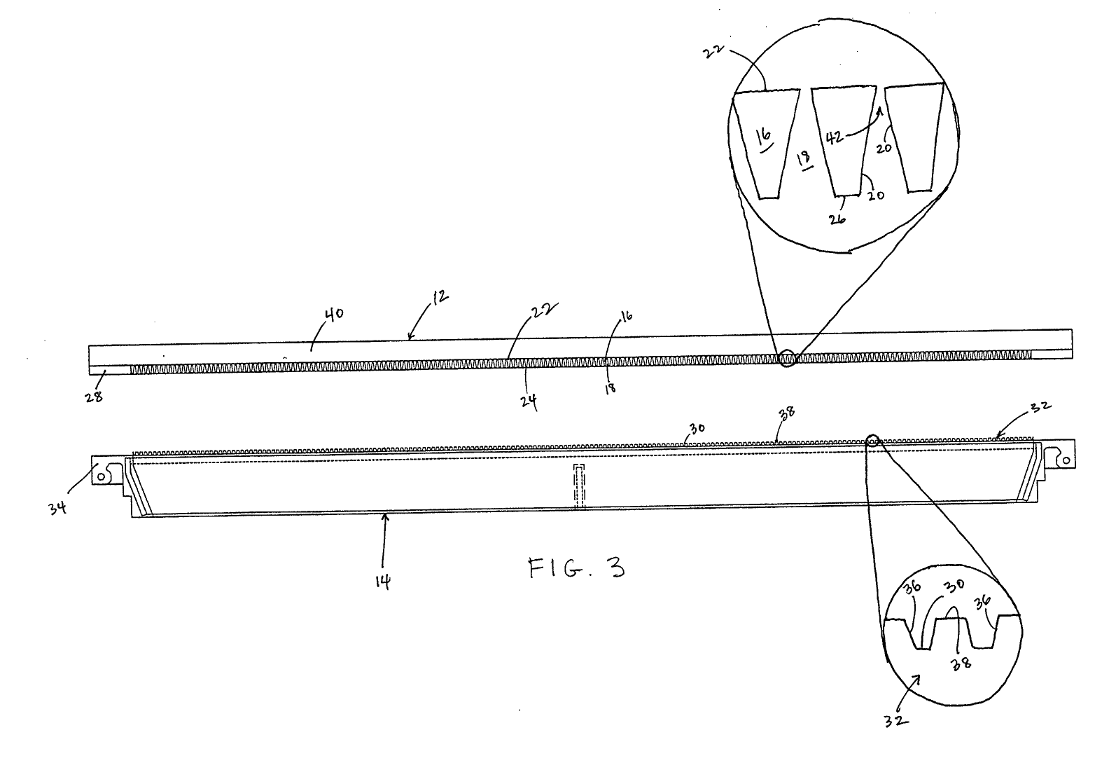

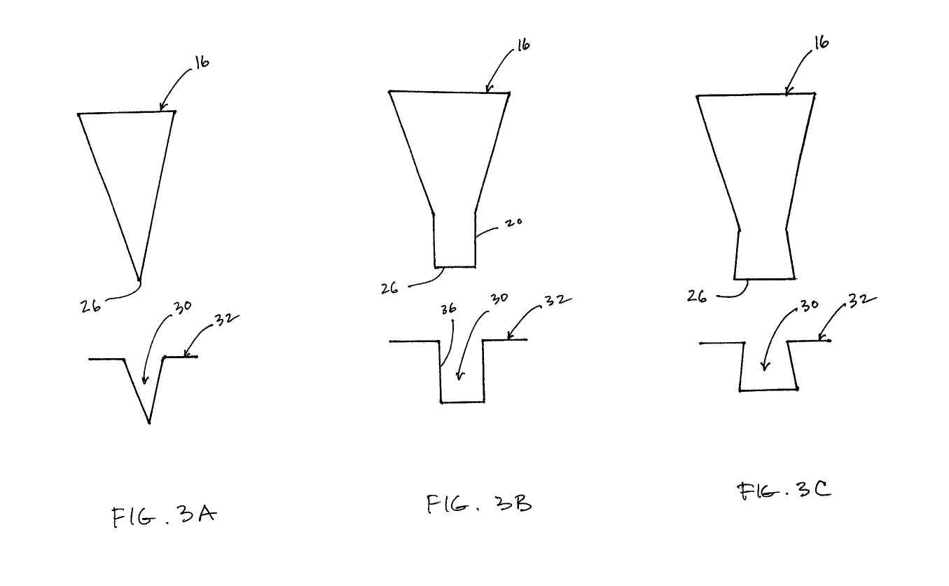

Referring to FIG. 2, the screen surface 12 is molded to include a plurality of surface filter members or wires 16 separated by filter gaps 18. Referring to FIG. 3, it can be seen that the filter members 16 preferably have a triangular-shaped profile or cross-section formed by angled filter sidewalls 20. In this way, the filter gap 18 widens in a direction of flow from a top filter surface 22 to a lower surface 24 of the screen surface 12. The lower surface 24 of the screen surface 12 is defined by lower ends 26 of the individual triangular-shaped profile filter members 16.

Referring to FIGS. 1, 2 and 3, it can be seen that the filter members 16 are integrally formed with a surface frame member 28 to create the overall screen surface 12. The surface frame member 28 positions the filter members 16 in their spaced-apart, parallel relationship to each other. However, because the filter members 16 are preferably molded of polyurethane, they are flexible and may move relative to each other, thereby causing the width of the filter gaps 18 to vary. Therefore, a series of top ribs 40 are integrally molded perpendicularly to the filter members 16 across the filter surface 22. And, the screen support 14 is integrally molded with a series of notches 30 that engage filter members 16 when the screen surface 12 is coupled to the screen support 14. The notches 30 are formed on a series of bottom ribs 32 that are held by a support frame 34 in a spaced-apart, parallel relationship to each other. The top ribs 40 and notched bottom ribs 32 serve to hold the filter members 16 at a consistent distance relative to each other. Because of this, with the top ribs 40 molded in place, the surface frame member 28 may be eliminated to create a greater open area for the screen panel 10. The top ribs 40 also act as dams positioned transversely to the direction of flow across the screen surface 12 to facilitate agitation of the product (e.g. coal) as it is being filtered by the screen panel 10.

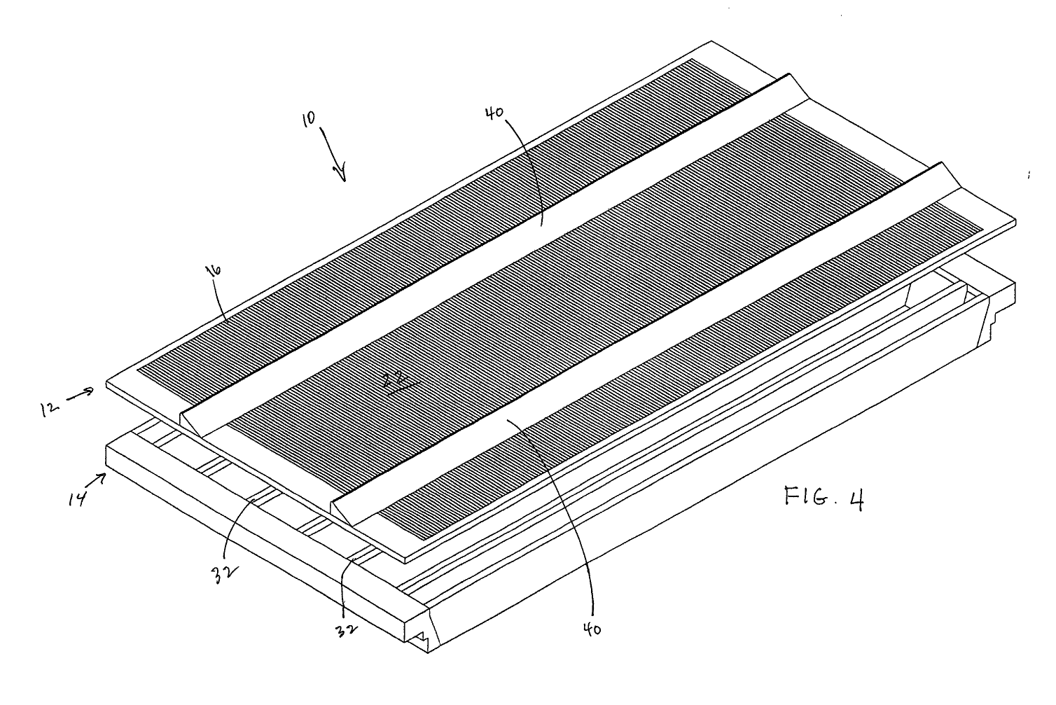

The screen panel 10 is formed by positioning the filter members 16 perpendicularly to the bottom ribs 32 and coupling the surface frame member 28 to the support frame member 34. In doing so, the lower ends 26 of the filter members 16 engage the notches 30. Again, in this way, the notches 30 cooperate with the top ribs 40 to hold the filter members 16 at a consistent distance relative to each other. As seen in FIG. 2, the screen support 14 is shown formed with four bottom ribs 32 formed with notches 30 and two top ribs 40. However, it will readily apparent to those of ordinary skill in the art that the number and spacing of bottom ribs 32 and top ribs 40 can be varied depending on various factors, including the intended use of the screen panel 10, the flexibility of the plastic used to mold the screen surface 12, etc. And, the filter members 16 may be glued into the notches 30 or may simply nest within the notches 30 without the use of adhesive. Further, the top ribs 40 may be used alone, without the cooperation of the notches 30, as will be further discussed below with reference to FIG. 4. Similarly, the notched bottom ribs 32 may be used without the cooperation of the top ribs 40.

Referring to FIG. 2, the width of the filter gap 18 can be changed by changing the spacing of the filter members 16. However, if the spacing of the filter members 16 is changed, the spacing between the notches 30 into which they fit must be changed accordingly. This means a unique screen support (with properly spaced notches 30) must be created for each screen surface 12 of a particular sized filter gap 18. According to the present invention, however, an alternative is to vary the width of the individual filter members 16, while maintaining their spacing. In this way, although the distance between the centers of two adjacent filter members 16 is not changed, the size of the filter gap 18 between the two filter members will change. This allows different screen surfaces 12 having different sized filter gaps 18 to be used with the same screen support 14. The spacing between notches 30 will correspond with the spacing between the centers of the filter members 16 for multiple sized filter gaps 18.

Referring to FIG. 3, the notches 30 include angled notch sidewalls 36 that mate with the filter sidewalls 20 when the filter members 16 engage the notches 30. However, notch sidewalls 36 extend only part way up filter sidewalls 20 when filter members 16 are positioned within the notches 30. In this way, an upper surface 38 of each support rib 32 does not extend to the top filter surface 22 of the filter members 16 and, therefore, does not obstruct flow through the narrowest, upper portions 42 of the filter gaps 18.

In addition to the matching angled filter sidewalls 20 and notch sidewalls 36, according to the present invention, other configurations may be used. For example, FIGS. 3A, 3B, and 3C, illustrate other configurations that may be utilized for holding the filter members 16 in place. Each of FIGS. 3A, 3B, and 3C illustrate a cross-section of a filter member 16 and a corresponding notch 30 formed in a support rib 32. FIG. 3A illustrates a filter member profile similar to that shown in FIGS. 1-3. However, the lower end 26 of the filter member 16 of FIG. 3A comes to a point instead of a flat face like the lower end 26 of the filter member 16 of FIGS. 1-3. Referring to FIG. 3A, the notch 30 matches the shape of the lower end 26 of the filter member 16 and thereby holds the filter member 16 relative to adjacent filter members when the screen surface 12 is coupled to the screen support 14.

Referring to FIG. 3B, the notch 30 again matches the shape of the lower end 26 of the filter member 16. In FIG. 3B, the notch 30 and lower end 26 of the filter member 16 are configured with parallel sidewalls 36 and 20, respectively. In addition to limiting side-to-side movement of the filter member 16, the lower end 26 of the filter member 16 of FIG. 3B may be sized to produce an interference fit with the notch 30, thereby limiting movement of the filter member 16 up and out of the notch 30 as well.

FIG. 3C illustrates yet another configuration according to the present invention of the filter member 16 and the notch 30. The lower end 26 of the filter member 16 of FIG. 3C is formed with a slight flare that matches the slight reverse taper of the notch 30 of FIG. 3C. In this way, the filter member 16 is “snapped” into notch 30 and the filter member 16 is held in place. As will be readily apparent to those of ordinary skill in the art, the slight flare of the lower end 26 of the filter member 16 shown in FIG. 3C must be chosen so that it can be removed from an injection mold. The degree of flare will be dependent at least partly on the plastic material being used to mold the screen surface 12. As mentioned with respect to the filter member/notch configuration shown in FIGS. 1-3, the filter members 16 illustrated in FIGS. 3A, 3B, and 3C may be glued into notches 30 or may be inserted into notches 30 without the use of adhesive, depending on the results desired.

Referring to FIG. 4, another embodiment of a screen panel in accordance with the present invention is shown with like parts from FIGS. 1 through 3 labeled with like numerals. The screen panel 10 in FIG. 4 is virtually identical to the screen panel 10 shown in FIGS. 1 through 3 except that the bottom ribs 32 of the screen support 14 are not formed with notches. Instead, the bottom ribs 32 include flat top surfaces on which the filter members 16 rest. In this way, the filter members 16 are held at a consistent distance relative to each other only by the top ribs 40, but are still supported by the bottom ribs 32 in a direction perpendicular to the top filter surface 22 of the screen surface 12.

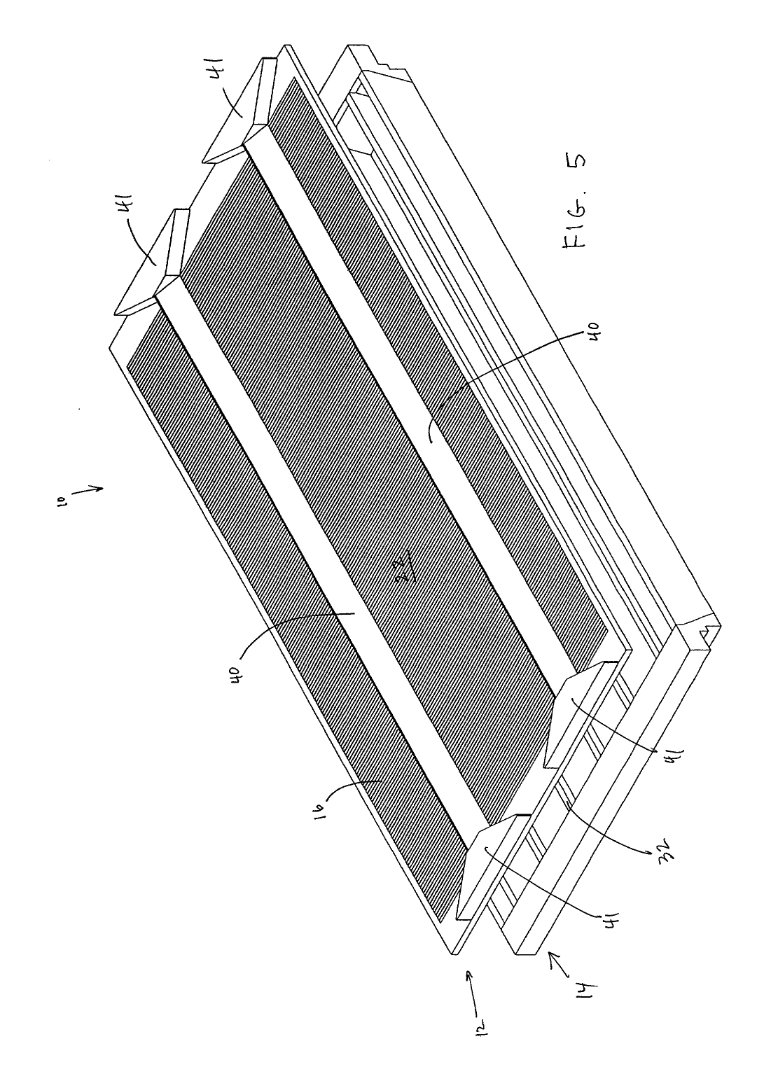

Referring briefly to FIG. 5, in another embodiment of a screen panel 10 in accordance with the present invention, the screen surface 12 is formed to include guides 41 at the ends of the top ribs 40. The guides 41 serve to direct the flow of product over the filter surface 22 and the top ribs 40.

Although the invention has been described in detail with reference to certain preferred embodiments, variations and modifications exist within the scope and spirit of the invention as described and defined in the following claims.

1. A method of manufacturing a screen panel, comprising the steps of:
forming a plastic screen surface having a plurality of elongated, spaced-apart, substantially parallel surface filter members, at least one end of each filter member being coupled to a surface frame member;
forming a plastic screen support having a plurality of elongated, spaced-apart, substantially parallel bottom ribs having spaced-apart notches formed along the length of the ribs, at least one end of each rib being coupled to a support frame member; and
coupling the surface frame member to the support frame member such that the surface filter members are positioned substantially perpendicularly to the bottom ribs and are substantially positioned to engage the notches.

2. The method of claim 1, further comprising the step of integrally molding a top rib to the plurality of filter members, the top rib being positioned on a filter surface defined by the plurality of filter members opposite the bottom ribs.

3. The method of claim 1, wherein the step of forming the plastic screen surface includes injection molding the plastic screen surface.

4. The method of claim 1, further including the step of gluing the surface filter members to the notches of the bottom ribs.

5. The method of claim 1, wherein the screen surface is made of polyurethane.

6. The method of claim 1, further including the step of providing the notches and the filter members with substantially matching sidewalls.

7. The method of claim 6, further including the step of providing the notches and the filter members with substantially matching angled sidewalls.

8. A method of manufacturing a screen panel, comprising the steps of:
injection molding a screen surface having a plurality of elongated, spaced-apart, substantially parallel surface filter members, the surface filter members having angled filter sidewalls and at least one end of each filter member being coupled to a surface frame member;
forming a plastic screen support assembly having a plurality of elongated, spaced-apart, substantially parallel bottom ribs having spaced-apart notches formed along the length of the ribs, at least one end of each rib being coupled to a support frame member, the notches having angled notch sidewalls substantially matching the angle of the filter sidewalls; and
coupling the surface frame member to the support frame member, wherein the surface filter members are positioned substantially perpendicularly to the bottom ribs and are substantially positioned to engage the notches with the angled filter sidewalls mating with the angled notch sidewalls.

9. The method of claim 8, further comprising the step of integrally molding a top rib to the plurality of filter members, the top rib being positioned on a filter surface defined by the plurality of filter members opposite the plurality of bottom ribs.

10. The method of claim 8, further comprising the step of gluing the surface filter members to the notches.

11. The method of claim 8, wherein the screen surface is molded of polyurethane.

12. A method of manufacturing a screen panel, comprising the steps of:
injection molding a screen surface having a plurality of elongated, spaced-apart filter members, the filter members having angled filter sidewalls;
forming a plastic screen support assembly having a plurality of elongated, spaced-apart bottom ribs; and
coupling the screen surface to the screen support, wherein the filter members are positioned transversely to the bottom ribs and are substantially positioned to lie on top surfaces of the bottom ribs.

13. The method of claim 12, further including the step of integrally molding a top rib to the plurality of filter members, the top rib being positioned on a filter surface defined by the plurality of filter members opposite the bottom ribs.

14. The method of claim 12, further including the step of gluing the surface filter members to the top surfaces of the bottom ribs.

15. The method of claim 12, wherein the screen surface is molded of polyurethane.

16. A screen panel, comprising:
a screen surface molded of plastic and including a plurality of substantially parallel, spaced-apart filter members and a top rib integrally coupled to the plurality of filter members and positioned on a filter surface defined by the filter members; and
a screen support including a plurality of substantially parallel, spaced-apart bottom ribs, the screen support coupled to the screen surface such that the bottom ribs are positioned adjacent the plurality of filter members opposite the top rib.

17. The screen panel of claim 16, further comprising a plurality of notches formed in the bottom ribs, the notches engaging the plurality of filter members.

18. The screen panel of claim 16, further comprising a guide integrally coupled to an end of the top rib.

19. The screen panel of claim 16, wherein the top rib is positioned substantially perpendicularly to the plurality of filter members.

20. The screen panel of claim 16, wherein the screen surface is molded of polyurethane.

21. A method of varying the width of a filter gap from a first screen panel to a second screen panel, the method comprising the steps of:
establishing a first filter gap width for the first screen panel, the first filter gap width being a measure of the space between spaced-apart adjacent first filter members of a first screen surface of the first screen panel, the first filter members having first centers that are spaced apart a first distance;
molding a screen support having a plurality of spaced-apart bottom ribs, the bottom ribs being formed to include a plurality of notches that are spaced apart a distance equal to the first distance; and
molding a second screen surface for the second screen panel, the second screen surface having adjacent second filter members that are of a different thickness than the adjacent first filter members, the second filter members having centers spaced apart a second distance equal to the first distance, thereby resulting in a second screen surface having a second filter gap width between adjacent second filter members that is different than the first filter gap width.

22. The method of claim 21, further comprising the step of coupling the second screen surface to the screen support, the second filter members of the second screen surface engaging the notches of the screen support.
